(19) United States
(12) Patent Application Publication
(10) Pub. No.: US 2019/0186353 A1
(43) Pub. Date: Jun. 20, 2019

(54) CONNECTING ROD FOR INTERNAL COMBUSTION ENGINE WITH ECCENTRICAL ELEMENT ADJUSTMENT ARRANGEMENT FOR ADJUSTING AN EFFECTIVE CONNECTING ROD LENGTH

(71) Applicant: ECO Holding 1 GmbH, Markheidenfeld (DE)

(72) Inventors: Christian Jung, Roden (DE); Dietmar Schulze, Muenzenberg (DE); Michael Seipel, Triefenstein (DE)

(21) Appl. No.: 16/210,325

(22) Filed: Dec. 5, 2018

(30) Foreign Application Priority Data
Dec. 19, 2017 (DE) DE102017130576.9
Feb. 15, 2018 (DE) DE102018103392.3

(51) Int. Cl. F02B 75/04; F02D 15/02; F16C 23/10; F16C 7/06; F16C 11/06

(52) U.S. Cl. CPC F02B 75/045; F02B 75/047; F02D 15/02; F16C 2360/22; F16C 7/06; F16C 11/0623; F16C 11/069; F16C 23/10

(57) ABSTRACT

A connecting rod for an internal combustion engine with an eccentrical element adjustment arrangement for adjusting an effective connecting rod length, the eccentrical element adjustment arrangement including at least one ball joint including a ball head that is arranged at a support rod and supported in a ball head receiver of a piston, wherein the ball head is secured at its outer surface in the ball head receiver by safety devices against sliding out of the ball head receiver, and wherein the safety devices are configured as a one-piece or a multi-piece annular safety element which is arranged in the piston at least partially bonded or form locking.

### RELATED APPLICATIONS

This application claims priority from and incorporates by reference German patent applications
DE 10 2017 130 576.9 filed on Dec. 19, 2017; and
DE 10 2018 103 392.3 filed on Feb. 15, 2018,

### FIELD OF THE INVENTION

The invention relates to a connecting rod for an internal combustion engine with an eccentrical element adjustment arrangement for adjusting an effective connecting rod length.

### BACKGROUND OF THE INVENTION

In internal combustion engines a high compression ratio has a positive effect upon an efficiency of the internal combustion engine. Compression ratio is typically defined as a ratio of an entire cylinder cavity before compression to a remaining cylinder cavity after compression. In internal combustion engines with external ignition, in particular gasoline engines that have a fixed compression ratio, the compression ratio, however, may only be selected high enough so that a so-called “knocking” of the internal combustion engine is prevented during full load operations. However, for much more prevalent partial load operations of the internal combustion engine, thus for a lower cylinder charge the compression ratio can be selected at a higher level without “knocking” occurring. The important partial load operations of an internal combustion engine can be improved when the compression ratio is variably adjustable. In order to adjust the compression ratio systems with variable connecting rod length are known.

DE 10 2005 055 199 A1 discloses a connecting rod in which a pivotable lever is inserted into a wrist pin connecting rod eye wherein an eccentrical element is inserted into a central opening of the eccentrical element. The eccentrical element is configured to receive a wrist pin. The lever forms a shaft-hub connection together with the eccentrical element. Since the joint is highly loaded during operations of the piston, requirements with respect to fabrication tolerances of the joining partners are high. The support rods that are supported at the upper connecting rod eye are supported by a ball joint in ball joint receivers and secured therein with transversal bolts.

### BRIEF SUMMARY OF THE INVENTION

It is an object of the invention to provide a connecting rod with a ball joint that is easy to assemble and has a high load bearing capability.

It is another object of the invention to provide an internal combustion engine with the connecting rod.

The object is achieved by a connecting rod for an internal combustion engine with an eccentrical element adjustment arrangement for adjusting an effective connecting rod length, the eccentrical element adjustment arrangement including at least one ball joint including a ball head that is arranged at a support rod and supported in a ball head receiver of a piston, wherein the ball head is secured at its outer surface in the ball head receiver by safety devices against sliding out of the ball head receiver, and wherein the safety devices are configured as a one-piece or a multi-piece annular safety element which is arranged in the piston at least partially bonded or form locking.

Advantageous embodiments and advantages of the invention can be derived from the dependent claims, the description and the drawing figure.

According to an aspect of the invention a connecting rod for an internal combustion engine with an eccentrical element adjustment arrangement for adjusting an effective connecting rod length is proposed, the eccentric element adjustment arrangement comprising at least one ball joint with a ball head that is arranged at a support rod and supported in a ball head receiver of a piston. The ball head is secured at its outer surface in the ball head receiver by securing devices against sliding out of the ball head receiver. The securing devices are configured as a one-piece or multi-piece annular securing element which is arranged in the piston at least partially bonded and/or form locking.

The connecting rod according to the invention for a variable compression internal combustion engine includes an eccentrical element adjustment arrangement for adjusting an effective connecting rod length which is defined as a distance of a center axis of a crank bearing eye from a center axis of a bore hole of an eccentrical element. The eccentrical element adjustment arrangement includes an eccentrical element that cooperates with a one-piece or multi-piece eccentrical element lever and in which a wrist pin of a cylinder piston is receivable. An adjustment travel of the eccentrical element adjustment arrangement is adjustable by a mechanical or hydraulic switch valve. The pistons of a hydraulic cylinder of the connecting rod are respectively movably supported in a cylinder bore hole and connected with support rods which are in turn pivotably linked at the eccentrical element lever.

A rotation of the adjustable eccentrical element adjustment arrangement can be initiated by an impact of mass forces (at low compression ε_{low}) and gas load forces (at high compression ε_{high}) of the internal combustion engine that impact the eccentrical element adjustment arrangement during an operating stroke of the internal combustion engine. Effective directions of forces that impact the eccentrical element adjustment arrangement change continuously during the operating stroke. The rotating movement or adjustment travel is supported by one or plural pistons that are integrated in the connecting rod and loaded with hydraulic fluid, in particular with motor oil, or the pistons prevent a resetting of the eccentrical element adjustment arrangement due to varying force effective directions of forces that impact the eccentrical element adjustment arrangement.

The support rods are respectively supported by a ball head in a ball head receiver of the piston and connected with the piston. The ball joint facilitates securing the support rods against sliding of the ball head out of an open end of the ball head receiver.

According to the invention the securing devices are configured as a one-piece or multi-piece annular securing element which is arranged in the piston in a simple manner at least partially bonded and/or friction locked.

Thus, a cost effective and reliable support piston safety can be provided to make operations safe and reliable. It is not necessary to provide an undercut in the ball head receiver in order to secure a safety ring or in order to provide bore holes in the piston for locking pins.

The axial clearance of the support rod in the support piston is individually adjustable by the safety element. Thus, it is possible to omit component tolerances or to permit a greater tolerance range. The clearance of the support rod can be reduced and is eliminated as a potential cause of failure for the connecting rod. Thus, expensive component production with low tolerances can be omitted.

According to an advantageous embodiment the safety element can be configured in two components and include a safety ring and an attachment ring. The safety ring can be made for example from metal or from a synthetic material, and it can be integrally provided in one piece with a slot and thus flexible. The safety ring can furthermore advantageously include a sliding bearing material. The safety ring can have a contour which can establish a flat contact with the support rod so that the Hertz surface pressure is advantageously reduced. The attachment ring can be advantageously made from metal so that it can be pressed and/or welded into the support piston. The attachment ring can be provided slotted. In particular the attachment ring can have an inner diameter in a non-slotted embodiment wherein the inner diameter can be greater than a diameter of the ball head of the support rod.

According to an advantageous embodiment the attachment ring can be pressed or welded into the piston. Thus, the attachment ring is fixed at the piston and secures the safety ring against falling out of the piston. This way the support rod can be secured against sliding out of the ball head receiver.

According to an advantageous embodiment the safety ring can be configured axially slotted. Thus, the safety ring can be configured flexible and is easily insertable into the receiver of the piston by radial compression.

According to an advantageous embodiment the safety ring can include an annular, radially inward cambered contact surface for the ball head. The contact surface facilitates a linear contact between the safety ring and the ball head. Thus it can be prevented that the support rod is connected with the piston in a geometrically overdetermined manner. Thus, the support rod can be pivoted easily relative to the piston.

According to an advantageous embodiment the safety element can be configured in one piece as a safety ring. The one-piece safety ring can be configured slotted or closed. The slotted version can be mounted in the receiver of the piston more easily, in particular when it is made from a flexible material. The closed version has the advantage that the wear through friction of the ball head on the safety ring is less and more uniform than in the slotted version where the contact surface between the ball head and the safety ring is smaller.

According to an advantageous embodiment the safety ring can be pressed or welded into the piston. Thus the safety ring is fixed at the piston and secured against sliding out of the piston. This way the support rod can be secured against sliding out of the ball head receiver.

According to an advantageous embodiment the safety ring can have an annular radially inward cambered contact surface for the ball head. The contact surface facilitates a line-shaped contact between the safety ring and the ball head. Thus, it can be prevented that the support rod is connected with the piston in a geometrically overdetermined manner. Thus, the support rod can be pivoted relative to the piston easily.

According to an advantageous embodiment the support rod can be configured as an assembled support rod with at least two components, wherein the support rod includes a rod element with a joint element and a piston connecting element that are arranged at opposite ends of the rod element, wherein the rod element can be connected with the joint element and/or the piston connecting element by a welding method and the piston connecting element can be configured as a ball head.

Advantageously the support rod can be assembled this way in a modular manner from simple components instead of being produced in complex processes as a turned component or milled component. Suitable materials can be advantageously provided for the components joint element, rod element and piston connector wherein the components can be connected by various suitable connecting processes with low complexity. Advantageously a friction welding method can be used in order to join components from different materials. Friction welding represents a cost effective joining method that is suitable for connecting components with various geometric shapes.

Advantageously the piston connecting element can be configured as a ball. A ball provides a high level of geometric freedom when connecting the piston. Thus, fabrication tolerances can be compensated in a suitable manner during subsequent operations. In particular the ball can be hardened in its entirety or at least in locations where the hardening is advantageous for preventing wear.

According to an advantageous embodiment the joint element can be configured as a ball. A ball forming the joint element represents a suitable and cost-effective joint element between the support rod and the eccentrical element lever. This way a high level of geometric freedom can be assured when moving the eccentrical element lever. Fabrication tolerances can be advantageously compensated.

According to an advantageous embodiment the joint element can be configured as a sleeve with a longitudinal axis that is parallel to the longitudinal axis of the rod element. In particular the rod element can include a pressed in bearing bushing. Through this embodiment of the joint element the connection between the support rod and the eccentrical element lever can be configured with low friction in a suitable manner so that reliable operations of the connecting rod can be provided long term. In particular the sleeve can be made from bronze and/or can include a sliding coating.

According to an advantageous embodiment the rod element can be configured as a tube. A tube is a very economical component since standardized material is available. Furthermore, a tube shaped rod element has an advantageous low weight compared to a component made from solid material while simultaneously providing a high level of bending stiffness. Alternatively, the rod element can also be made from solid material.

According to an advantageous embodiment a cross section of the rod element can be configured polygonal. This way rod elements can be advantageously provided with a surface moment of inertia that provides bending stiffness. The polygonal shape can be selected according to the load bearing requirements. Various geometries are available in standard materials.

According to an advantageous embodiment the rod element can be configured integrally in one piece together with the joint element. A support rod of this type is an advantageous embodiment with a joint element formed directly thereon. In particular, the joint element can be configured as a bail so that a ball rod can be used for this application.

According to another aspect of the invention, an internal combustion engine with variable compression is proposed that includes at least one connecting rod. Thus, a connecting rod with at least one ball joint as described supra can be advantageously used in order to advantageously implement an eccentrical element adjustment arrangement and an advantageous combustion process and thus low fuel consumption of the internal combustion engine.

### BRIEF DESCRIPTION OF THE DRAWINGS

Further advantages can be derived from the subsequent drawing description. The drawing illustrate an embodiment of the invention. The drawings, the description and the claims include several features in combination. A person skilled in the art will advantageously view the features also individually and will combine them into additional useful combinations, wherein:

FIG. 1 illustrates a connecting rod with two ball joints in a longitudinal sectional view;

FIG. 2 illustrates a support rod with a piston according to a first embodiment of a connecting rod according to the invention in a side view;

FIG. 3 illustrates the support rod according to FIG. 2 in a longitudinal sectional view of the sectional plane A-A;

FIG. 4 illustrates a support rod with a piston according to another embodiment of a connecting rod according to the invention in a top view;

FIG. 5 illustrates the support rod according to FIG. 4 in a longitudinal sectional view of the sectional plane A-A;

FIG. 6 illustrates the support rod according to FIG. 4 in a longitudinal sectional view in the sectional plane B-B;

FIG. 7 illustrates a support rod with two balls according to another embodiment in an isometric view; and

FIG. 8 illustrates the support rod according to FIG. 7 in a longitudinal sectional view,

### DETAILED DESCRIPTION OF THE INVENTION

In the drawing figures identical or like components are designated with identical reference numerals. The drawing figures merely illustrate exemplary embodiments and do not limit the spirit and scope of the invention.

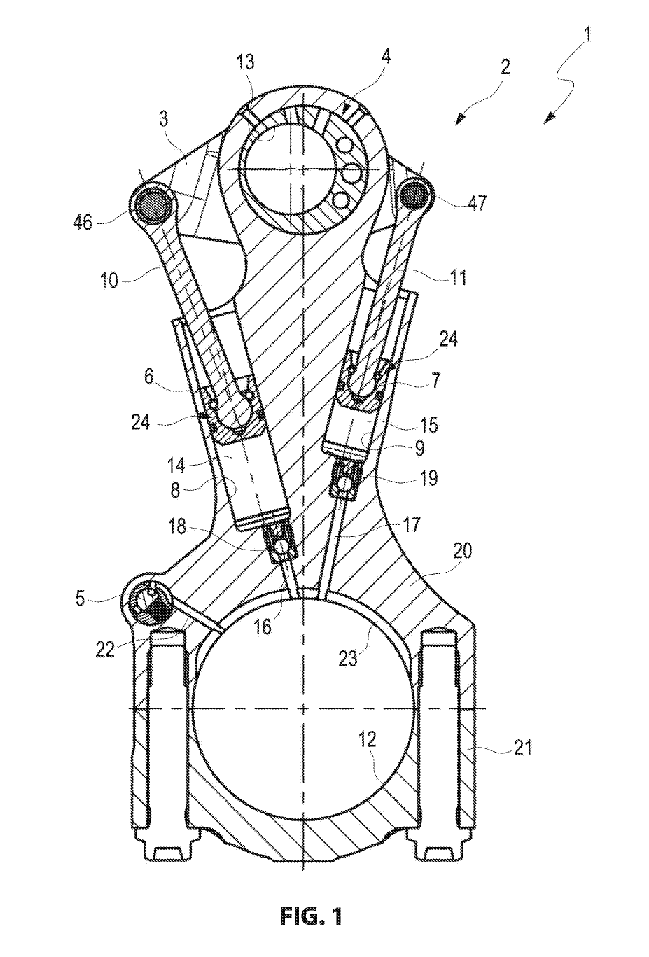

FIG. 1 illustrates a schematic view of an exemplary connecting rod 1 for a variable compression internal combustion engine with an eccentrical element 2 for adjusting an effective connecting rod length which is defined as a distance of a center axis of a crank bearing eye 12 from the center axis of the bore hole of an eccentrical element 4. The eccentrical element adjustment arrangement 2 includes an eccentrical element 4 that cooperates with a one-piece or multi-piece eccentrical element lever 3 in which a non-illustrated wrist pin of a cylinder piston is receivable. An adjustment travel of the eccentrical element adjustment arrangement 2 is adjustable by a mechanical or hydraulic switch valve 5.

A rotation of the adjustable eccentrical element adjustment arrangement 2 is initiated by an impact of high mass forces (at low compression ε_{low}) and gas load forces (at high compression ε_{high}) of the internal combustion engine that impact the eccentrical element adjustment arrangement 2 during an operating stroke of the internal combustion engine. During the operating stroke (operating cycle) effective directions of torques that impact the eccentrical element adjustment arrangement 2 change continuously. The rotating movement or adjustment movement is supported by one or plural pistons 6, 7 that are loaded with hydraulic fluid, in particular with motor oil, and that are integrated in the connecting rod 1 or the pistons 6,7 prevent a resetting of the eccentrical element adjustment arrangement 2 due to varying force effective directions of forces impacting the eccentrical element adjustment arrangement 2.

The pistons 6, 7 are respectively moveably supported in a cylinder bore hole 8, 9 of a hydraulic cylinder 14, 15 of the connecting rod 1 and connected with support rods 10, 11 which are in turn pivotably connected with the eccentrical element lever 3. In an exemplary manner the support rods 10, 11 of the eccentrical element adjustment arrangement 2 are connected by cylindrical rollers 46, 47 with the eccentrical element lever 3.

The connecting rod 1 includes the crank bearing eye 12 for connecting the connecting rod 1 with a crank shaft of an internal combustion engine and a wrist pin bearing eye 13 for connecting the connecting rod 1 with the cylinder piston of the internal combustion engine.

The pistons 6, 7 are moveably arranged in cylinders 14, 15 formed by the cylinder bore holes 8, 9, configured as hydraulic chambers and loaded through inlets 16, 17 from the crank bearing eye 12 with hydraulic fluid, e.g., motor oil, through the check valves 18, 19. Thus, the check valves prevent a backflow of the hydraulic fluid from the hydraulic chambers 14, 15 back into the inlets 16, 17, but they facilitate a pulling of hydraulic fluid into the hydraulic chambers 14, 15.

The hydraulic chambers 14, 15 are furthermore connected through non-illustrated drains with the switch valve 5 which can be configured as a hydraulic valve or as a mechanical valve and which is connected with the crank bearing eye 12 through a drain conduit 22.

It is evident that the connecting rod 1 includes a connecting rod body and a connecting rod cover attached thereto.

A groove 23 is provided on a circumference of the crank bearing eye 12 in the portion of the connecting rod body 20 wherein inlets 16, 17 and the drain conduit 22 lead into the groove. Since the groove 2 is only arranged on a portion of the crank bearing eye 12 the load bearing capability of the bearing in the crank bearing eye is only impaired by a minimum amount.

The configuration of the described connecting rod 1 is only represented in an exemplary manner and the eccentrical element lever connection according to the invention can also be used in other variants of the connecting rod with an eccentrical element adjustment arrangement. Thus is possible for example to arrange the switch valve 5 in the portion of the connecting rod cover 21. Furthermore the described check valves 18, 10 can be provided integrated in the switch valve 5. Also the hydraulic supply of the hydraulic chambers 14, 15 can deviate from the described embodiment.

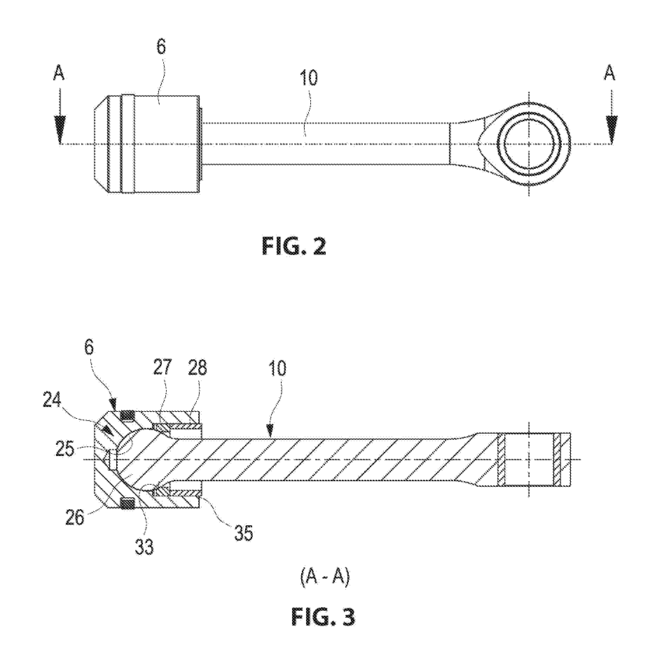

FIGS. 2-6 include support rods 10 in two embodiments of the connecting rod 1 according to the invention. As a matter of principle the supports rods 10, 11 and the pistons 6, 7 are configured identical and merely differ in diameter. Therefore the support rod 10 is respectively illustrated and described in an exemplary manner.

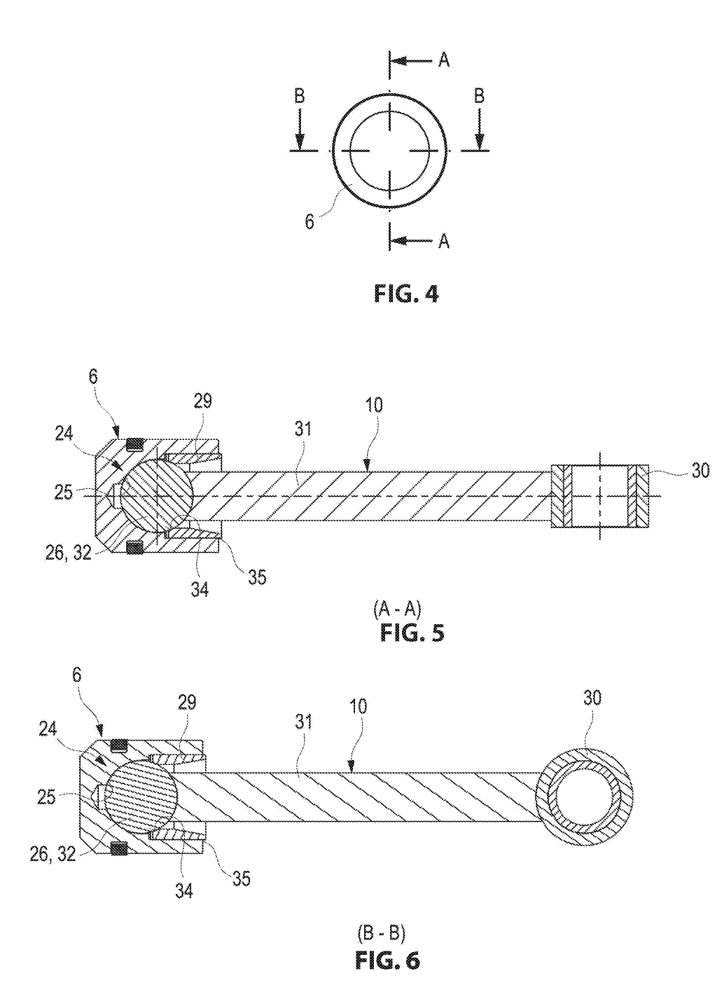

FIGS. 2 and 3 illustrate the support rod 10 according to a first embodiment. FIGS. 4-6 illustrate a second embodiment. The support rod 10 respectively includes a ball joint 24 and a ball head 26 that is arranged at the support rod 10, wherein the ball head is supported in a ball head receiver 25 of the piston 6. The ball head 26 is secured at its outer surface in the ball head receiver 25 by safety devices against sliding out of the ball head receiver 25.

The ball head receiver 25 includes a cambered base element that is adapted to the outer contour of the ball head 26 and on which the ball head 26 can slide to facilitate tilting the support rod 10.

A one piece or multi piece safety element is configured as a safety device according to the invention wherein the safety element is at least partially bonded or arranged in a form locking manner in the piston 6, 7.

The first embodiment is evident from FIG. 3 wherein the safety element is configured in two components and includes a safety ring 27 and an attachment ring 28.

The safety ring 27 can be configured for example from metal or from a synthetic material. The configuration can be configured in one piece, flexible or in two pieces.

The safety ring 27 can additionally include a contour shaped as an annular radially inward cambered contact surface 33 for the ball head 26, wherein the contour provides a contact area for the support rod 10 in order to reduce the Hertz surface pressure.

The safety ring 27 can be configured axially slotted in an alternative embodiment in order to be able to run the safety ring over the support rod 10 by slight expansion during assembly.

The attachment ring 28 is configured from metal and provided pressed or welded into the piston 6 in order to individually adjust the axial clearance of the support rod 10. The attachment ring 28 can be slotted or it has an inner diameter in a particularly advantageous embodiment wherein the inner diameter is greater than the ball diameter of the support rod 10 so that the attachment ring can be configured unslotted. The attachment ring can be welded e.g., at the free edge 35 of the piston 6,

According to a second embodiment that is illustrated in FlGS. 4-6 the safety element is configured as a one piece safety ring 29 as illustrated in FIGS. 4-6.

Furthermore the support rod 10 is not provided in one piece in FIG. 5 but configured as an assembled support rod and includes the components joint element 30, rod element 31 and piston connector element 32, wherein the piston connector element 32 is configured as a ball head 26. The components joint element 30, rod element 31 and piston connector 32 are connected with each other by a welding method.

Generally the support rod 10 can be configured as an assembled support rod with at least two components and the components joint element 30, rod element 31 and piston connector 32 or the components rod element 31 with integrated joint element 30 and piston connector 32 or the components rod element 31 with integrated piston connector 32 and joint element 30, wherein at least two of the components are connected with each other by a welding method. Advantageously the piston connector 32 is configured as a ball head 26 in order to facilitate easy tilting of the support rod 10 relative to the piston 6.

The joint element 30 is configured as a sleeve whose longitudinal axis is configured orthogonal to the longitudinal axis of the rod element 31. In particular the joint element 30 includes a pressed in bearing bushing. Alternatively, however, it is also possible that the joint element is configured as a ball.

The rod element 31 can be advantageously configured as a tube which has rather high bending stiffness for a rather low weight. Alternative also a rod element with a polygonal cross section or with another profile for a surface moment of inertia that is optimized for bending stiffness can be used. Furthermore the rod element 31 with the joint element 30 can be integrally configured in one piece in an advantageous embodiment.

Before welding the ball 32 down advantageously the safety ring 29 is pushed over the support rod 10. Thus, the unslotted safety ring 29 that is pressed into the piston 6 or welded to the piston 6 can be configured in a simple and more cost effective manner with reduced tolerances. The safety ring 29 can be welded e.g. to the free edge 35 of the piston 6.

Alternatively it is also possible that the safety ring 29 is provided slotted but flexible. Then the safety ring 29 can also be slid over an assembled support rod 10 and can apply from an inside against the ball head receiver 25 of the piston 6 when the safety ring 29 is sized accordingly and can be fixated at this location e.g. by welding.

Also the safety ring 29 advantageously has a contour with an annular radially inward cambered contact surface 34 for the ball head 26, wherein the contact surface provides a contact area with the support rod 10 in order to reduce the Hertz surface pressure,

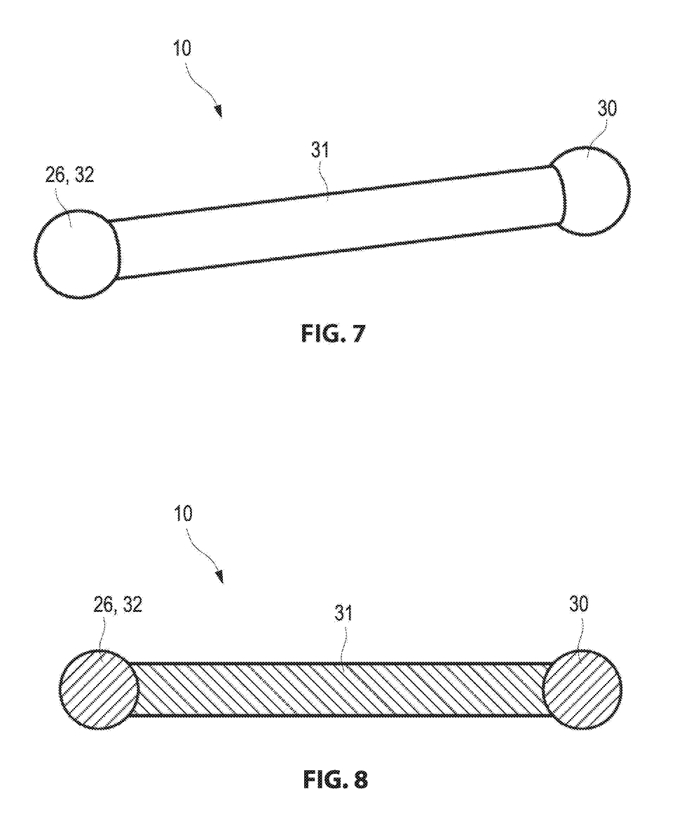

As another embodiment illustrated in FIGS. 7 and 8 the support rod 10 includes a ball for a link element 30 as well as for a piston connector 32 which is connected with the respective ends of a rod element 31. This variant can be produced particularly well in combination with a one piece eccentrical element lever 3 that has been produced by a metal injection molding (MIM) method or by a fine casting method. Advantageously standard elements like hardened balls can be used for the joint element 24 and for the piston connector 26 and rods or tubes can be used for the rod element 25.

What is claimed is:

1. A connecting rod for an internal combustion engine with an eccentrical element adjustment arrangement for adjusting an effective connecting rod length, the eccentrical element adjustment arrangement comprising:
at least one bail joint including a ball head that is arranged at a support rod and supported in a ball head receiver of a piston,
wherein the ball head is secured at its outer surface in the ball head receiver by safety devices against sliding out of the bail head receiver, and
wherein the safety devices are configured as a one-piece or a multi-piece annular safety element which is arranged in the piston at least partially bonded or form locking.

2. The connecting rod according to claim 1, wherein the safety element is configured in two components and includes a safety ring and an attachment ring.

3. The connecting rod according to claim 2, wherein the attache gent ring is pressed or welded into the piston.

4. The connecting rod according to claim 2, wherein the safety ring is configured axially slotted.

5. The connecting rod according to claim 2, wherein the safety ring includes a radially inward cambered contact surface for the ball head.

6. The connecting rod according to claim 1, wherein the safety element is configured as a one piece safety ring.

7. A connecting rod according to claim 6, wherein the safety ring is pressed or welded into the piston.

8. The connecting rod according to claim 6, wherein the safety ring includes an annular radially inward cambered contact surface for the ball head.

9. The connecting rod according to claim 1,
wherein the support rod is configured as an assembled support rod made from at least two components,
wherein the support rod includes a rod element with a joint element and with a piston connector,
wherein the joint element and the piston connector are arranged at opposite ends of the rod element,
wherein the rod element is connected with the joint element or with the piston connector by a welding method and the piston connector is configured as a ball head,

10. The connecting rod according to claim 9, wherein the joint element is configured as a ball.

11. The connecting rod according to claim 9,
wherein the joint element is configured as a sleeve whose longitudinal axis is configured perpendicular to a longitudinal axis of the rod element,
in particular wherein the joint element includes an impressed bearing bushing.

12. The connecting rod according to claim 9, wherein the rod element is configured as a tube.

13. The connecting rod according to claim 9, wherein a cross section of the rod element is configured polygonal.

14. A connecting rod according to claim 9, wherein the rod element is configured integrally in one piece together with the joint element.

15. A variable compression internal combustion engine comprising: at least one connecting rod according to claim 1.
